(19) United States
(12) Patent Application Publication
(10) Pub. No.: US 2009/0236442 A1
(43) Pub. Date: Sep. 24, 2009

(54) Injection device for an internal combustion engine

(75) Inventor: Tjeerd Sijtse IJsselstein, Nieuw Roden (NL)

Correspondence Address: YOUNG & THOMPSON, 209 Madison Street, Suite 500, ALEXANDRIA, VA, 22314, US

(73) Assignee: TDC PRODUCTS B.V., RC NIEUW RODEN (NL)

(21) Appl. No.: 11/953,160

(22) Filed: Dec. 10, 2007

(51) Int. Cl. B05B 3/02

(52) U.S. Cl. 239/214

(57) ABSTRACT

An injection device for injecting fuel into a combustion chamber, includes:

a housing rigidly connected to the combustion chamber,

an injection part rotatably connected to the housing and drivable by an actuator in order to rotate with respect to the housing about a central axis,

a supply conduit fluidically connected to the combustion chamber for the pressurized introduction of a fuel into the combustion chamber and which includes a fluid-tight coupling between the housing and the injection part;

an injection nozzle rigidly connected to the injection part and which includes an atomizer having an atomizer opening fluidically connected to the supply conduit for introducing fuel into the combustion chamber, whereas the injection nozzle rotates, and

at least one further supply conduit for the pressurized introduction of a fluid into the combustion chamber.

### BACKGROUND OF THE INVENTION

The invention relates to an injection device for the injecting of fuel into a combustion chamber.

The invention further relates to an internal combustion engine provided with an injection device.

The invention further relates to a method for the injecting of fuel and/or fluid into a combustion chamber of an internal combustion engine.

DE 19816339 discloses an injection device having a rotatable injection part, which can be driven by a driving force. One problem with this device is that under certain circumstances a combustion chamber equipped with this injection device may generate too many undesirable emissions.

### SUMMARY OF THE INVENTION

An object of the invention is to help to reduce undesirable emissions.

For this purpose, the invention provides an injection device for the injecting of fuel into a combustion chamber, wherein the injection device comprises:

a housing which is rigidly connected to the combustion chamber,

an injection part which is rotatably connected to the housing and which is drivable by means of an actuator in order to rotate with respect to the housing about a central axis,

a supply conduit which is fluidically connected to the combustion chamber for the pressurized introduction of a fuel into the combustion chamber and which comprises a fluid-tight coupling between the housing and the injection part;

an injection nozzle which is rigidly connected to the injection part and which comprises an atomizer having an atomizer opening which is fluidically connected to the supply conduit for the introduction of fuel into the combustion chamber, whereas the injection nozzle rotates,

the injection device further comprising at least one further supply conduit for the pressurized introduction of a fluid into the combustion chamber.

An advantage of the invention is that it is possible to introduce successively or simultaneously various combinations of fuels and/or moderators into the combustion chamber under beneficial mixing conditions.

In one embodiment of the injection device, the fluid comprises a further fuel. This further fuel differs, for example, from the fuel and is in this case introduced into the combustion chamber shortly after the ignition of the first fuel, and this broadens the freedom of choice for the further fuel, wherein fuels which would not per se produce beneficial combustion may be considered.

In one embodiment of the injection device, the fluid comprises a moderator to moderate the combustion process, as a result of which the emission of thermal NOₓ is, in particular, combated. The moderator used may, for example, be water, hot steam or a suitable chemical substance. A further beneficial effect is that thermal expansion of the moderator helps to improve the output when an internal combustion engine is provided with the injection device.

In one embodiment of the injection device, the actuator comprises a converter for the pressurized conversion of the fluid or the fuel into a driving force to rotate the injection part with respect to the housing.

In one embodiment of the injection device according to any one of the preceding claims, wherein the fluid-tight coupling comprises a peripheral channel which is provided on the rotatable injection part to produce a fluidic connection between the housing and the injection part, irrespective of their mutual rotational position.

In one embodiment of the injection device, the injection nozzle comprises:

blades for swirling fluid in the combustion chamber,

a central cavity around which the blades are arranged,

and recesses in the blades,

to circulate fluid in the combustion chamber along the injection nozzle. This provides within the combustion chamber internal recirculation of exhaust gases, and this contributes to more complete combustion and improved emission values.

In one embodiment of the injection device, the blades are provided, in this case at their end remote from the central axis, with an atomizer and the atomizers are located in a plane substantially perpendicular to the central axis and atomizer openings are oriented to inject the fuel or the fluid into the combustion chamber at an angle to the plane. This provides improved swirling of the fuel and moderator in the combustion chamber.

In one embodiment of the injection device, supply conduits each open into a separate atomizer, so the fuel and the fluid mix only in the combustion chamber.

In one embodiment of the injection device, the injection part comprises an electrode in order electrostatically to influence the fuel and/or the fluid by applying a charge or influencing the charge distribution so as to produce better mixing in the combustion chamber in order to promote the issuing of free radicals.

In one embodiment of the injection device, the electrode is provided at the supply conduit to the atomizer in order electrostatically to influence the fuel and/or the fluid.

In one embodiment of the injection device, the electrode is provided in the central cavity in the injection nozzle in order electrostatically to influence fuel present in the combustion chamber and/or the fluid.

In one embodiment, the injection nozzle comprises an electrically conductive layer in order to heat the fuel and/or the fluid.

In one embodiment of the injection device, an ignition means is further provided in order to supply energy and to influence the combustion process. Preferably, the ignition means is a pulsed laser diode, for example the HL6750MG visible high power laser diode, which is outside and remote of the combustion chamber, and the laser pulse is introduced into the combustion chamber via a collimator (or else a light-beam localizer) and through a quartz crystal window.

In one embodiment of the injection device, the injection part comprises a catalytic layer of, for example, barium oxide in order to speed up the combustion process.

In one embodiment of the injection device, the injection part is provided with at least one sensor and the injection part and the housing are provided with electromagnetic signal transmission means in order contactlessly to transmit data between the housing and the injection part.

In one embodiment of the injection device, the sensor comprises a temperature sensor in order to measure the temperature in the combustion chamber.

In one embodiment of the injection device, the sensor comprises a pressure sensor in order to measure the pressure in the combustion chamber.

In one embodiment of the injection device, the pressure sensor comprises a piezo element. It is possible for the pressure sensor to be accommodated in a cooled container in order to cool the element and associated electronics.

In one embodiment of the injection device, the injection device comprises a generator, terminals of the generator being provided on the injection part in order to produce electrical energy on the injection part.

In one embodiment of the injection device, the injection nozzle comprises at least one exit surface from which fluid issues at an exit speed perpendicularly to the exit surface and wherein the injection nozzle has a speed component in the exit surface that is greater than the exit speed. This further promotes homogenization of the mixture in the combustion chamber and further prevents agglomeration of injected particles.

The invention further relates to an internal combustion engine provided with an injection device according to any one of the preceding claims.

In one embodiment of the internal combustion engine, the engine selected from the following group: a diesel engine, a petrol engine, a gas engine and a turbine.

In one embodiment of the internal combustion engine, the rotation of the injection part is in the direction of the swirl in the combustion chamber.

The invention further relates to a method for the injecting of fuel and/or fluid into a combustion chamber of an internal combustion engine, including one or more of the following steps:

rotating the injection part,

injecting in succession various fuels into the combustion space over one combustion cycle,

measuring the temperature in the combustion space,

measuring the pressure in the combustion space,

measuring the NOₓ content,

injecting a moderator in order to moderate the combustion process and/or to influence the temperature,

supplying ignition energy into the combustion space,

electrostatically influencing the fluid in the combustion space.

Advantages of this method include better combustion and improved emission.

In one embodiment of the method, the injection part rotates before the fuel is injected in order to obtain an optimum temperature distribution for injecting of the fuel.

In one embodiment of the method, gases which have reacted within a combustion chamber of the internal combustion engine are mixed with non-reacted gases in order to take part in the next combustion process within the combustion chamber.

In one embodiment of the method, the fuel is injected at an angle to the central axis such that the fuel does not strike any parts of the combustion chamber in order to reduce thermal loading and erosion of the parts of the combustion chamber.

In one embodiment of the method, the fuel is injected at pressure and the injection part rotates at speed so as to prevent agglomeration of fuel particles.

In one embodiment 29 of the method, the injection part rotates during the inlet stroke in order to reduce the ignition delay. As a result of improved mixing, the mixture enters the combustion chamber more rapidly and is ignited more completely.

In one embodiment of the method, the injection part rotates during the working stroke in order to combat the formation of soot.

In one embodiment of the method, the injection part rotates during the outlet stroke in order to promote afterburning and thus to reduce emissions.

In one embodiment of the method, the injection part is not driven over a portion of the combustion cycle in order to save energy.

In one embodiment of the method, after initiation of the combustion the temperature in the combustion chamber is measured and adjusted, by injecting of a moderator, to below a temperature level at which thermal NOₓ is produced.

In one embodiment of the method, the leakage rate is regulated per combustion cycle and per combustion chamber in order to eliminate mutual differences in capacity between combustion chambers. The leakage rate is the flow of fuel which is produced when an atomizer opening is not sufficiently closed off by, for example, a needle as a result of, for example, wear or contamination.

In one embodiment of the method, a needle closes the atomizer opening as a result of centripetal normal force during rotation of the injection part. This provides a predictable closing force as a function of the rotational speed of the injection part.

In one embodiment, the injection device is provided with one or more of the characterizing features described in the appended description and/or shown in the appended drawings.

In one embodiment of the method, the method includes one or more of the characterizing steps described in the appended description and/or shown in the appended drawings.

It will be clear that the various aspects mentioned in the present patent application may be combined and may each be considered individually for a separate patent application.

### BRIEF DESCRIPTION OF THE FIGURES

Various embodiments of a . . . according to the invention are represented in the appended figures, in which:

FIG. 1 is a side view in cross section of a first embodiment of an injection device;

FIG. 2a is a side view in cross section of a second embodiment of an injection device;

FIG. 2b is a view from below of the injection device from FIG. 2;

FIG. 3 is a perspective view of an injection part;

FIG. 4 is a plan view of the injection part from FIG. 3;

FIG. 5 is a side view in cross section of the injection part from FIG. 5;

FIG. 6 is a side view as in FIG. 5 but in a different position;

FIG. 7 is a perspective view of a third embodiment of an injection device;

FIG. 8 is a process diagram of a combustion installation;

FIG. 9 is a process diagram for the extraction of CO₂ from flue gas;

FIG. 10 is a diagram of a known process for the production of methanol;

FIG. 11 depicts a piezo pressure transducer;

FIG. 12 is a graph showing the test results of the pressure transducer from FIG. 11;

FIG. 13 is a perspective view of a diffuser;

FIG. 14 is a side view of the diffuser in an injection device; and

FIG. 15 shows a detail from FIG. 14.

### DESCRIPTION OF EMBODIMENTS

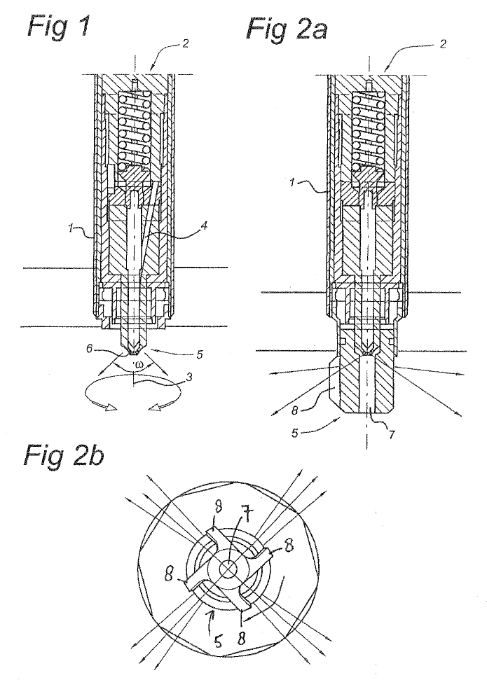

FIG. 1 is a side view in cross section of a first embodiment of an injection device. The housing 1 is rigidly connected to the combustion chamber (not shown). The injection part 2 is connected to the housing by means of, for example, ceramic bearings which are known per se so as to be able to rotate about a central axis 3. The injection part 2 is driven by an actuator (not shown). The injection part contains in this case a standard injector with a spring and a needle valve. The injection nozzle 5, which is rigidly connected to the injection part 2, reaches into the combustion chamber. The fluid is led via a supply conduit 4 to the injection nozzle 5, after which it is introduced under pressure into the combustion chamber via the atomizers 6. It is conceivable that the actuator comprises a converter which converts the pressurized fuel or fluid flow into a driving force in order to rotate the injection part.

FIG. 2a is a side view in cross section of a second embodiment of an injection device. In this case, the injection nozzle 5 is provided with blades 8 which swirl the gases in the combustion chamber when the injection part 2 rotates with the injection nozzle 5. The injection nozzle 5 is in this case provided with a central cavity 7. When fitted in a combustion chamber, the direction of rotation of the injection nozzle 5 is preferably adapted to the design direction of the swirl, so these intensify each other.

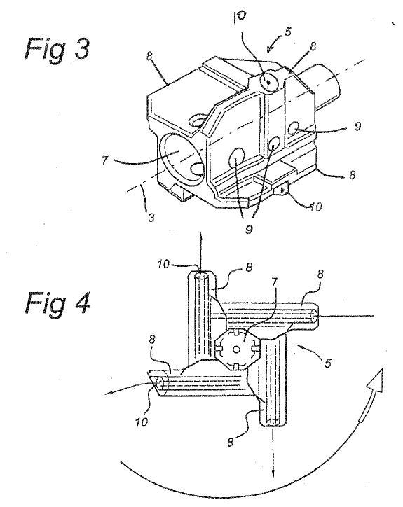

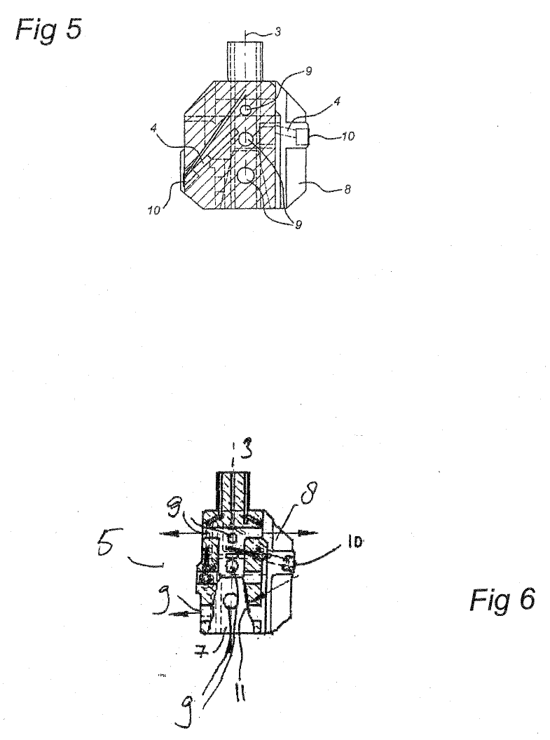

FIG. 3 to 6 show the injection nozzle 5 of the second embodiment of the injection device in various views and/or positions. The injection nozzle 5 is in this case made of ceramic. The blades or vanes 8 are in this case provided with recesses 9 which are fluidically connected to the central cavity 7. As a result, gases, including exhaust gases, are circulated in the combustion chamber in order again to take part in a combustion process, and this has a beneficial effect on emissions. The supply channels 4 open into the atomizers 10. It is conceivable that an atomizer 10 is closed off by a needle (not shown) which is held in a closed position by centripetal normal force during rotation of the injection nozzle 5 in order to close the atomizer opening in the atomizer 10. In this case, the supply channels 4 are at various angles to the central axis 3 in order to inject fuel and/or fluid into the combustion chamber at various angles, thus providing better distribution. In the atomizer 10, there is provided in this case an electrode (not shown) in order electrostatically to influence the fuel and/or the fluid flow by the application of potential to the electrode. An electrode 11 is also accommodated in the cavity 7 in order electrostatically to influence the gases in the combustion chamber.

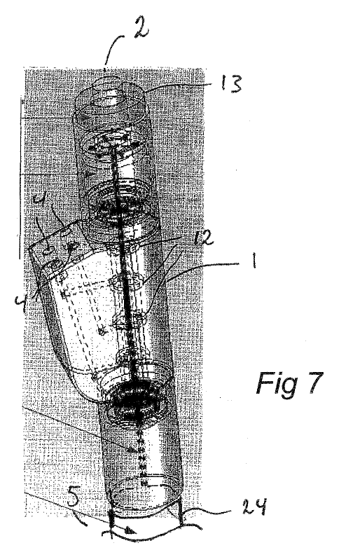

FIG. 7 is a perspective view of a third embodiment of an injection device. In this case, there are provided a plurality of supply conduits 4 which in this case each open into their own atomizer 10 from FIG. 3-6, so the fuel and the fluid mix only in the combustion chamber. The supply conduits 4 are each activated separately by, inter alia, valves. It is conceivable that valves are provided on the injection nozzle 5 from FIG. 3-6. The supply conduit 4 comprises a fluid-tight connection 12 or coupling 12, which is known per se, between the injection part 2 and the housing 1 in order to form a tight connection 12 for a pressurized fluid, between the fixed housing 1 and the rotatable injection part 2. The control unit of the injection device is provided partly fixed to the housing (module 13), partly on the injection part 2 and partly in the module 24 fastened to the injection nozzle 5. The control unit comprises, inter alia, a microcontroller provided in this case on the injection part 2. The module 24 comprises sensors to measure, inter alia, temperature, pressure and NOₓ content and actuators, for example a piezo valve, which in a closed position closes a supply channel 4 and in an open position opens a supply channel. Signals are transmitted between the injection part 2 and the housing 1 electromagnetically, for example by optocouplers. A generator (not shown) is provided in this case in order to provide the injection part 2 with electrical energy, the terminals being located on the injection part 2.

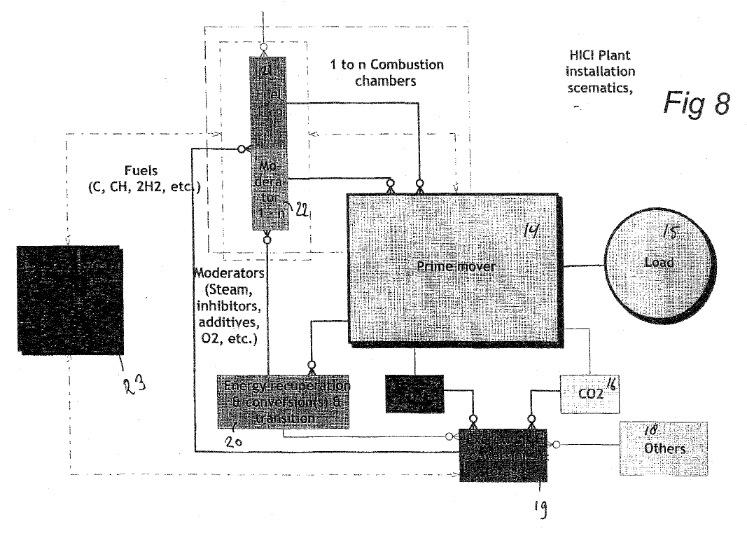

FIG. 8 is a process diagram of a combustion installation, the recuperation and conversion of energy being provided In FIG. 8, the reference numerals refer in sequence to the combustion chamber 14, the load 15, CO₂ extraction and/or storage 16, H₂O extraction and/or storage 17, other processes and/or storage 18, precipitation, conversion and storage 19, energy recuperation, conversion and transition 20, fuel storage 21, storage 22 of moderators and process control 23.

### INDUSTRIAL APPLICABILITY

Emissions of fine matter and ultrafine matter as a result of the combustion of (fossil) fuels in prime movers: At-source approach to prevent the formation of fine matter and ultrafine matter such as are formed in the traditional combustion of fuels in prime movers. Can be used for liquid, powdered and gaseous fuels or a combination thereof.

### Formation of Soot:

Soot, in summary, is a collective name for crack products (3^{rd} order chemical reactions, pyrolysis, (naphtha) cracks) which are formed when, for example, liquid fuels (diesel oil, lubricating oils petrol, etc.) degrade under the influence of high temperatures before they can evaporate and successively combust (=oxidation). The long chain structure of most fuels also contributes to this. By-products such as aldehydes, olefins/alkenes, naphthenes, aromatics, ketones, aliphatics, etc. are the result thereof. Around a core (nucleus) of, for example, C₂H₂. . . n (acetylenes), crack products agglomerate, partially as a result of polycondensation, to form “soot particles”, also referred to as PM (PM=particulate matter) having dimensions ranging from a few nanometres to larger particles of matter. Generally, two grades are specified: PM₁₀ (aerodynamic particle size of 10 μm) and PM_{2.5} (aerodynamic particle size of 2.5 μm).

(Poly)condensation of polycyclic aromatics and aliphatics (from the gas phase) increases the particle size. Owing to ongoing developments in, for example, diesel engines, the dimensions of the emitted particles have gradually become smaller, whereas the production of ultrafine matter has risen exponentially as a result. Particles of<100 nm are most represented in number, albeit not in mass, in the exhaust gases of, for example, diesel engines.

The “static” injection process thus in fact causes soot in the form of (ultra)fine matter, irrespective of the type of fuel. The present generation of petrol engines experience the same problem.

The above-mentioned PM particles are subsumed under the heading “fine matter”, including all grades. The author distinguishes particles of≦200 nm which belong to the category of ultrafine matter.

Examples of other constituents which are often referred to under the collective name “fine matter” include salt air, worn tyres, worn brakes, nitrogen oxides, building materials, etc. The different types of fine matter have very different adverse effects on human life and the environment. Thus, for example, salt air fine matter has hardly any discernible detrimental effects.

In view of the fact that in addition to PM originating from combustion processes, nitrogen oxides generated from the same combustion processes also have comparable adverse effects on the health of living beings, this will also be considered in the description for the present innovation.

Soot filters are generally incapable of trapping ultrafine PM particles (<200 nm), despite the fact that these pose the greatest threat to the health of mammals. In this connection, reference is also made to the WHO reports which are unequivocal about this. The effectiveness of soot filters has to date usually been expressed in terms of gravimetric efficiency. This fulfils the cosmetic aspects of soot filters: there are few if any visually perceivable columns of black smoke! After all, the micron and submicron level of aerodynamic particles is also not discernible to the naked eye.

It is estimated that diesel engines are responsible for approx. 75% of all fine matter and ultrafine matter produced. Another large proportion is of anthropogenic origin.

On account of its comparable adverse effect on health, NOₓ is also subsumed under the heading “fine matter”.

The fact that “soot” is produced generally means that combustion has been incomplete. In addition to the above-mentioned fine matter emissions, this also yields PAHs, etc. including ozone-forming gases. In this connection, the literature often uses the term NMHCs (non-methane hydrocarbons). Gas chromatography, for example, can be used to demonstrate several hundred chemical compounds as exhaust gas emissions in diesel engines (EN590 fuel). FAME (fatty acid methyl ester) fuels thus give rise to “other” problems and exhaust gas emissions.

The discussions concerning CO₂ are meaningful only if the fuels are burned completely. This is by no means the case when significant amounts of harmful (by-)products of combustion are encountered. CO is one example of these. Demonstrable CO after the combustion process is a sure sign of incomplete (i.e. “poor”) combustion.

The combustion process in prime movers is many times more complex than that indicated hereinbefore and the discharge of emissions is not easy to describe; however, the emission of ultrafine matter into the environment has become a social problem that calls for an at-source approach. The fine matter to be combated is just one of the noxious substances to which attention must be given as quickly as possible.

### Adverse Effect of PM on (Inter Alia) the Airways:

In the case of mammals, the airways (but also the skin) are able to get rid of a certain amount of noxious substances having “relatively coarse dimensions” via natural processes. Examples include the cilia in the bronchi. However, in such cases, the smaller the particles, the more pernicious the effects. The smallest particles (which according to medical reports are<5 μm) easily disappear in the pores of the tissues where they should in principle be regarded as carcinogens and often cause cell damage, bronchitis and infections. This situation is to some extent comparable to NOₓ, to which (human) skin is also permeable, as a result of which NOₓ can become attached directly to blood platelets and are in this way carcinogenic. In the reproduction of mammals, it is been found that ultrafine matter can be transferred by the parents to the foetus, thus transferring a potential health risk. The WHO has been able to define no lower limit with regard to particle size and exposure to (ultra)fine matter. The economic repercussions of fine matter are estimated in the case of the Netherlands (as an example) to be between C= 20 and 40 billion per year, whereas the number of premature human deaths caused each year by fine matter is estimated to be approx. 20,000, i.e. roughly one seventh of all deaths, or on average one death every 30 minutes. Obviously, this is not just a Dutch problem. The problem has not been brought to public attention on a large scale and calls for a better international approach, despite the thorough reports which have been drawn up on this subject (for example within the EU).

It may therefore be concluded that ultrafine matter, as a byproduct of prosperity, poses a large threat to human health and is damaging the environment in the broadest sense. In general, “the public” expects adequate government measures, but the means for these are often too limited and not equipped for an adequate approach.

### Measures Against Soot (PM):

In order to combat soot emission, “the prior art” has in many cases deployed methods in order to solve the problems retrospectively, i.e. instead of tackling the problems at source, new technologies have been developed and implemented to minimize the harmful effects after they have occurred. The use of “soot filters”, as with the introduction of catalytic converters after NOₓ had been produced as a by-product as a result of ongoing technical developments, is an example of this. The effectiveness of these soot filters is known to be extremely limited precisely in the field of application in which they had to be deployed, namely the combating of ultrafine matter. In particular, a soot filter is able effectively to trap merely relatively coarse particles (which usually have an aerodynamic diameter of>5 μm and only in a few cases of>200 nm and are by definition the less harmful particles), whereas the vast majority of ultrafine matter (=by definition the most harmful particles) is allowed through. On top of this, whereas fuel consumption, and therefore also the production of CO₂, can rise by up to 6%, there are also the cost price, the maintenance and maintenance costs, the health risks, etc. of the filters.

Scientifically, there are still serious concerns about the effects on the composition of exhaust gas emissions and the damage they cause to public health if soot filters are used and/or in combination with chemicals. As vehicle fuels are in practice often a “dumping ground” for “excess” chemicals, these concerns would seem to be well founded. Examples include the possible risk of the formation of dioxins if chlorinated hydrocarbons are contained in the fuel. Other examples include substances (such as, for example, sulphur) which are removed from the fuels for road transport and dumped in fuels for shipping.

None of the soot filters known to us are able to trap particles of<200 nm, whereas fuel consumption (and therefore also the production of CO₂) can increase by up to 6%.

None of these filters ensure that, of the previously trapped agglomerate of soot particles, no relatively small particles (for example carbon particles) are still entrained in the treated exhaust gas stream, as a result of the fact that the adhesive forces of the agglomerate are low.

A number of measurements have revealed that soot filters crush a substantial portion of the agglomerated PM to form an ultrafine matter and that therefore the amount of ultrafine particles after a soot filter can be several times greater than before the filter and in engines not equipped with a soot filter. These ultrafine particles subsequently do not take part in the confirmation measurement in order to comply with the PM standard because these particles are now too small for this purpose. However, there is no question that they are very much still present and extremely harmful! “What the eye doesn't see the heart doesn't grieve over”. Unfortunately, “what the eye doesn't see” is all too often regarded as being “clean”. This “invisibility” also applies to the average opacity measurements which cannot measure or can hardly measure ultrafine matter because they are not sensitive enough.

The gravimetric effectiveness of a soot filter or its reduction in opacity is not a direct measure of “healthier” air and does not otherwise determine what “good air quality” is.

Not all engines/prime movers are suitable for the retrospective fitting of a soot filter; this often impairs the engine management, not least because of the type of filter and an increase in the counterpressure in the exhaust gas system and lambda values which fall outside the discrimination window. A further risk is “contamination” of the filter substrate.

The combination of the type of fuel and type of soot filter cannot easily be altered because this would ultimately cause significant damage to the prime mover and/or filter substrate.

The effectiveness of a soot filter is limited outside the operating temperature, i.e. the filter cannot be used at “low or excessively low” temperatures. Long-term low temperature is generally an indication of spontaneous “burnout” of the clogged substrate, and this poses a threat to the immediate environment. The surplus of air incorporated in the design concept of the prime mover (in the case of fixed valve timing) cools under these circumstances the average exhaust gas temperature to below the necessary operating temperature.

Some of the filters require chemicals such as, for example, urea.

Others require adaptation to the fuel injection system in order, for example, to regenerate the filter with the acetylenes from the fuel, which are formed as a result of injecting at the “wrong moment” into the cylinder.

So much for the “retrospective” approach.

We advocate an at-source approach to the problem involving the development of products which seek not only to save fuel, as a result of the more efficient and more flexible use of fuels, but also to reduce emissions, including ultrafine matter.

### BACKGROUND AND CONSIDERATIONS

### A) Prior Art I: Statically Fitted Injectors

In the case of standard injectors which are positioned statically in the combustion space, the injected fuel builds up to form a “solid” column of liquid from the exit opening in the injector. The cross section of this (divergent) column is a number of times greater than the diameter of the exit opening in the nozzle and the length thereof can in some situations reach up to the cylinder wall.

Usually, the total surface area of the plumes of injected fuel and mixture constitute from about 20% to 50% of the instantaneous volumetric surface area, whereas the design conditions for swirl and squish have been found to have particularly little bearing on the plume. The result thereof is a λ (=fuel/air ratio) which is highly position-dependent in the combustion space, the cause of which is non-optimum distribution. This may also be deduced from the fact that the density ρ in the combustion space displays marked local differences in an almost stationary state.

With regard to technologies for direct injection into combustion chambers, current engine development is, for the most part, continuously seeking to increase injection pressures and to develop multilayered combustion, multiple injections, common rail v. jerk-type pumps and to optimize combustion chamber geometry with regard to swirl and squish. None of these methods has been able to rule out nullification of the agglomerated liquid jets, so during combustion a large amount of fine matter is still produced as a result of 3^{rd} order chemical reactions which in many cases entail the additional drawback of excessive erosion of combustion chamber material. This development route necessarily leads to exceptionally high weights of the mechanical components of the fuel pump drive.

### B) Prior Art II: Measuring of (Ultra) Fine Matter

Although the World Health Organization (WHO) has pointed in a plurality of reports to the health risks implicit in fine matter, the measuring of fine matter, and in particular ultrafine matter, is not simple and to date no standards have been introduced for this purpose. The WHO has not been able to define any safe lower limit with regard to exposure to an absolute particle size.

It is expected that the current standard (PM 10) for a particle size of 10 μm will be replaced by PM 2.5. In gravimetric terms, this is a practicable standard, although unfortunately this standard can hardly serve as a measure of health risks. No standard for (measuring) particles in the most harmful range as far as health risks are concerned will therefore be available in the immediate future, so a certain gap may be said to exist. The lack of standards does not mean that there are no potential risks.

### C) Prior Art III: Aftertreatment of Exhaust Gases

A great deal of research and development is currently being conducted into the aftertreatment of exhaust gases. However, to date the results of this research have not borne any fruit for the nanometre particle range. There are serious misgivings about, for example, the deployment of soot filters which, in particular, may allow the ultrafine matter back out of the filter packet and, in addition, produce other harmful emissions. In this regard, the following particulars should also be noted:

1) Some types, which may or may not be combined for the aftertreatment of soot and NOₓ, require the use of chemicals (for example urea carriers). This presents a threat during operation and also a potential risk of additional emissions including, for example, dioxins, etc.

2) Some types require daily maintenance, as a result of which (concentrated) PM again enters the environment, placing the operators at risk if no supplementary precautions are taken. To date, no legislation has been introduced to control this, placing additional responsibility on the shoulders of manufacturers and owners (EC standardization, for example).

3) All types of soot filter experience a high increase in counterpressure in the exhaust gas system, and this goes hand in hand with an increase in specific fuel consumption and emissions including CO₂. In some cases, an increased CO content after the catalytic converter has been reported as a result of the catalytic process.

4) All types of soot filter take up a large amount of the space and loading capacity of the vehicle on which/in which the filter is positioned.

5) All types of soot filter require additional investment for fitting, (daily) maintenance, consumables, replacement and disposal of the residue and soot filter material on replacement.

6) All types of soot filter are unsuitable or hardly suitable to be fitted to existing installations.

The formation of soot is represented schematically hereinafter (cf. Gilles Bruneaux et al.), for which purpose a peak occurs in what is known as the degenerate branching phase before the active radical R 'O₂ from the RH oxidation process initiates destruction of the process.

The cone of (liquid) fuel, which is “cracked” owing to high temperatures in the outer shell, results in SOOT. In the outer shell of the plume, the fuel is sprayed most finally and enters the gaseous state. As a result, this part of the fuel burns most rapidly (issuing of free radicals) In this shell, there is produced, inter alia, NOₓ, usually as a result of “deficiencies” in the mixing of air and fuel.

PM from approx 2 nm-25 μm is regarded as being carcinogenic. The WHO has not been able to define a lower limit. NOₓ is toxic, sticks to blood platelets and causes, inter alia, acid rain and residual products: aldehydes, olefins/alkenes, naphthenes, aromatics, ketones, aliphatics, etc.

### Innovation

On principle and in the conviction that problems can be tackled best at source, the present invention considers mainly the causes of the aforementioned emissions and asks how these causes can be eliminated. At the same time, the focus extends to a broader range of applicability of the invention with regard to both types of fuel and universal deployment in a broader scope of application than just one kind/type of prime mover.

In the case of the Roto Atomizer, the design philosophy is to reduce the volume per injected fuel particle by, inter alia, preventing a “solid cone of liquid” by allowing the atomizer to rotate (in a standard or adapted manner). The design allows for a rotational speed as a function of at least the parameters to be expected in the combustion space but also for the properties of the fuels to be used and conditions prevailing in the injection system at any given moment. Various types of fuel can therefore call for various minimum rotational speeds. The Sauter droplet diameter and what is known as the “Monte Carlo” discrete particle description are not applicable in this regard insofar as the exit opening, which may or may not be supplemented with the swirling effect of the turbine (RV), produces in combination with the rotational speed a particle distribution such that individual liquid particles no longer interact. For this purpose, a standard atomizer can be positioned in a turbine housing (Roto Vanes) having openings for the atomizer output.

Situation on Transition from an Atomizer to a Combustion Chamber on a Basic Fuel Particle

The injection period is intermittent and is usually at most approx. 30 crank angle degrees, and this is “merely” approx. 4% of a complete cycle (based on the 4-stroke principle).

The Roto Vanes can be driven over a much longer period of time per cycle with the following effects which also form part of the innovation:

1. During the last portion of the compression stroke, possibly as a result of the formation of peroxides during this phase of adiabatic/isentropic compression, there are formed hotspots (high density gradients occur) in which, inter alia, prompt NO is produced. This indicates a non-homogeneous (temperature) distribution in the compression space, as a result of which parasitic energy is already consumed in this phase. A turbulent gas stream assumes optimum temperature distribution prior to injection, i.e. an improvement of the swirl and squish.

2. During the injection phase, there is a continuous central “supply” of “fresh” gas mixture from the combustion chamber to the fuel which has been introduced under rotation and is therefore distributed more finely, thus producing more intimate contact between the two. This leads to more rapid transition to the gas and diffusion phase of the fuel which is distributed over a much larger working area of the combustion space, so the heat release is also distributed over a larger surface area and the nuclei are bound not merely to the plume. At the same time, not only the fuel but also the gases are mixed directly and intimately with the fuel and, during the liquid phase (which for a standard injector is extremely short) in the combustion space, fuel particles are surrounded by the gases, as a result of which evaporation and mixing take place rapidly and homogeneously.

3. The liquid is no longer sprayed against components of the combustion chamber and as a result these components are subjected to less intensive thermal loading and the erosion resulting from the abrasive effect of free radicals decreases.

4. During the heat release, the fuel, which may still be in liquid form, will, as a result of the (optimized) spread, assume a lower density for a standard injector, thus leading in the final analysis to a marked reduction in cracked fuel and therefore also soot. Bertrand Naud et al. have carried out, inter alia, pdf (particle density function) and mdf (mass density function) studies as a particle stochastic approach to turbulent sprays and flames, concluding: “It is not possible to come out with a complete model where both phases have independent discrete representations”.

5. During the working stroke, soot is produced via the acetylene hypothesis, the hydrogen route or the carbon root. All three “methods” of soot formation and the long chain structure of some fuels are, inter alia, partly dependent on “the lack of direct and intimate contact” with O₂, so a marked if not complete reduction of soot is also the result during the working stroke of the Roto Vanes.

6. As a result of the bringing of the gas mixture into strong turbulence (this is a desired state situation), in which the centrally positioned hole also acts as a “suction tube”, gases which are still in the reaction phase or which have already completed this phase are supplied to the (diffusion) process and thus occur as moderators. (This is comparable to the known principle of EGR according to which some (approx. 60%) of the treated gases are supplied to complete cycles in order thus to act as ballast substances in order to combat the production of, for example, NOₓ). Marked local fluctuations in density with respect to the weighted instantaneous average are thus reduced if not eliminated.

7. The exhaust stroke of the cycle suggests that the “combustion has already long passed”. Chemical reactions of the gases do not comply with this strict separation of piston motions; they simply continue, even long after they have left the exhaust conduit. The same is true of soot, whatever its origin. The additional turbulence allows any unburned compounds still to be (post-)oxidized even in this phase of the cycle.

8. This leads to a shorter ignition delay (of up to a few msec) for standard injectors, as a result of which there are a longer time and more crank angle degrees for the (more complete) reacting of the fuel and thus also less PM is produced.

9. The pulse energy is accordingly released in a shorter period of time (immediately after TDC), and this improves efficiency and contributes to cleaner combustion.

10. One of the (side) effects is a decrease in thermal and prompt NOₓ. Fuel-bound NOₓ is not expected to produce substantial reduction, merely in the proportion of reduction in specific fuel consumption and in proportion of reduction resulting from any ballast flows present.

11. Another (side) effect is improved combustion and smoother engine running from a cold start, owing to an extremely homogeneous mixture formation. The traditional cold start smoke and cold start hunt are thus also prevented.

12. Overall, the Roto Vane should be inactive for just approx. 25% of the cycle. It may be possible to extract the required energy from the intermittent flow of fuel

13. This will result in homogenized filling during each phase of the cycle.

14. The design on which the present patent application is based allows a plurality of types of fuel (liquid, powdered, gaseous or combinations thereof) to be injected into the combustion space per combustion cycle or per unit of time. This is important above all if, when a single fuel is used, deposits or other undesirable products are to be expected. This is the case with certain biofuels having, for example, a high acid content (certain FAME fuels and the like). This technology also eliminates a second drawback of certain biofuels, namely the consequences of the absence of a discernible ignition delay with regard to, for example, EN590. The injecting of fuels having these types of properties only once, for example, the heat release of the first injected fuel has been detected then provides the advantage that this fuel takes part “instantaneously” in the combustion process. Most of these types of fuels (such as, for example, pyrolysis oils) cannot (easily) be mixed with, for example, EN590 but can, with the present innovation, be used at the same time as energy sources. For each injection channel, a fuel associated with this injection channel can be injected into the combustion chamber in a timed and metered fashion.

15. If the above-mentioned fuels are used, traditional injectors give rise to the risk of condensation on machine parts such as, for example, cylinder head gaskets and piston walls. If the Roto Atomizer, or else the HICI injector, is used, these risks are avoided.

16. If a moderator, for example (hot) water, steam or a chemical substance, is added via this process, once for example the initiation reaction has been detected, the maximum peak temperature can then be “adjusted” or limited to below the level at which thermal NOₓ is produced. This is also at-source combating of undesirable emissions that has the additional advantage of thermal expansion and accordingly is not fully parasitic and can thus positively influence the output of the installation.

17. Both fuels and moderators can in some cases be generated by the installation for which the prime mover is deployed and be processed almost immediately: examples of these include gases which can be formed by means of electrolysis, such as H₂ and O₂, and hot water and steam from, for example, heat recovery installations and collectors.

18. All known injectors, such as those for example used in diesel engines, are provided with a leakage oil discharge. This leakage oil is used partly as a lubricant and partly as a coolant. A drawback of this process is that wear results in mutual differences in leakage rate leading, in an open loop-controlled prime mover, to mutual differences in capacity between the individual combustion chambers, unless the controller is provided with SDICs (smart diesel injection controls) provided by EPCO. In the latter case, the flow rate is controlled in a forward feedback loop for each cycle and for each cylinder/combustion chamber, and this provides a weighted and averaged load balance between a plurality of combustion chambers. In the case of the HICI injector, individual injectors (which may be individually controllable for each type of fuel) are placed in the rotary body, wherein the (minimum) leakage losses are supplied directly to the turbulent stream, so evaporation occurs even before agglomerated drops and/or jets may result.

19. The centripetal normal force is, at a constant angular velocity ω of the injector assembly, a fixed value as a function of the mass of the (needle) body and ω, in contrast to a fully spring-loaded needle (or spherical body) of a standard injector of which the (spring) constant decreases over time to the detriment of the opening pressure of the injector, whereas wear processes markedly push up the leakage oil flow rate over time and thus detract from the efficiency of the atomizer function.

20. During the warm-up phase of the prime mover, a conductive layer attached to the design can be connected to a voltage source which ensures that the gases and the fuels are (pre)heated, thus increasing the heating speed, and this also reduces the discharge of particles and emissions.

21. Fitting in the design of a pressure transducer, for example a piezo element which has intensified charge and follows the electronics which are fitted in the less hot portions of the design, allows the course of the process for each working cycle to be accurately monitored and to be used, by means of the (externally positioned) electronic controller, for uniform distribution of power between combustion chambers, precise timing of the individual flows of fuel to the respective atomizer outlets, etc., etc.

22. The proposed design outlined as an example is ideal for electrostatic influence. The swirled gases are supplied, inter alia, via the central hole in order to be distributed by the blades. There is produced, as it were, gas conveyance as a result of the centrifugal effect of the blades. The gases can thus be electrostatically charged in this central opening, and this has a positive influence (shorter ignition delay, complete and more rapid chemical reactions) on the ignition and (post-)combustion process; i.e. electrostatic influence of the gas stream (fresh mixture, compressed, combustion cycle and exhaust gas cycle).

23. This process can be intensified and optimized still further by imparting an opposite charge to the fuel at/via the exit openings in the injectors.

24. In order to be able to bring about still more precise timing of the injection process, additional (auxiliary) energy (electric discharge, laser pulses, etc.) can, under specific operating conditions, be supplied in order to initiate the ignition process or to allow the combustion process to continue reacting.

25. HICI or homogeneous injection compression ignition (which needs to be registered as a trade mark/model) can, as a counterpart to HICI (homogeneous charge compression ignition), be used for all known types of fuel of fossil, synthetic or biological origin in a liquid, (semi-)gaseous, powdered or mixed/combined state.

26. For spark ignition engines, the abbreviation stands for homogeneous injection charge ignition.

27. HICI is suitable for the “adding” of moderators and/or chemicals in order to influence the combustion process and/or to influence emissions.

28. HICI is suitable for the treatment of media which cannot burn beneficially in isolation but can do so in combination with other fuels.

29. HICI is suitable for all prime movers in which fuels (for example in combustion chambers) are made to react exothermically and, in particular, for diesel engines, petrol engines, gas engines and (gas) turbines.

30. HICI allows pilot, post-, multiple and continuous injections to be carried out in a “simple” manner. For each type of fuel, fuel can be added (and timed) for each respective nozzle integrated in the assembly.

31. Compared to conventional technologies, HICI also allows a marked reduction both in PAHs (NMHCs) and in ozone-forming emissions.

32. With HICI, a reduction in CO₂ is expected, albeit a not inconsiderable reduction if a soot filter is used.

33. With HICI, a reduction of CO is expected, certainly compared to the use of a soot filter.

34. HICI allows a reduction in NOₓ to be achieved, certainly compared to the use of soot filters (in particular open/half-open systems).

35. With HICI, the risk of 8 strokes is greatly reduced, especially if no leakage oil is returned.

36. HICI has a mechanical backup in case the drive fails or is deactivated.

37. HICI allows the use of fuels which are not possible for conventional systems such as, for example, pyrolyzed plastics materials which have a destructive effect in normal injection systems because acid radicals are condensed under almost all conditions.

38. HICI allows these fuels to be used in the diffusion phase of a (base) fuel in cases in which the acids cannot lead to condensation and therefore do not damage the engine. Expensive dehydrogenation processes carried out on the fuel can therefore be dispensed with.

39. HICI can be used for conversion to existing installations with a class upgrade and can also be used on newly constructed installations. The geometry can be customized for each type of installation.

40. The use of catalytic layers on, for example, the vanes of the blades can speed up (chemical) reactions.

41. The use of catalytic layers can prevent the deposition of combustion remnants.

42. The use of catalytic layers can prevent exit cavitation on the nozzles.

43. The direction of rotation of the Roto Atomizer/HICI is preferably in the design direction of the swirl.

44. The use of HICI and/or Roto Atomizer allows the mechanical design to be made lighter for pump drives than is the case for conventional atomizers. Overall, this saves energy throughout the production process and lifetime cycle of the prime movers.

45. The HICI design allows fuels having a broad range of viscosities to be treated.

46. In the case of HICI, sensors and actuators are attached “in the combustion chamber” by means of the rotating part. The energy required to operate the sensors and actuators is supplied by generating secondary energy by means of the “dynamo” principle or by providing contactless energy transfer by means of electromagnetism. The transmission of data from sensors and the activation to actuators are also carried out contactlessly by means of (axially or radially positioned), for example, optocouplers and/or (high) frequency signals and/or electromagnetic transmission. Dedicated microelectronic modules, the static and the dynamic (rotating) portion being positioned in a mutually contactless manner and so as to be electrically isolated from each other, then provide the processing and transmission of the signals (see for example FIG. 8). The static portion of the transmission interface is subsequently connected to the outside world on, for example, a smart diesel injection controls module. The electronics are placed in a precisely positioned EMC-safe cylindrical metal cage which is reinforced with fibreglass, whereas the upper edges of the components (ASICs) are oriented radially toward the centre, thus preventing the centripetal force from causing a contact break. The assembly as a whole is balanced and centrifugally treated with a synthetic resin which is sufficiently flexible to accommodate temperature effects and solid enough to fix the item in place. For this purpose, the connection of the wiring to sensors and actuators, which are placed in the ceramic housing, is (mechanically) attached without power. Needless to say, the electronics, which are fitted so as to be able to rotate, do not have any points of contact with the static outside world.

47. Overview of possible (physical) variables which can be measured by sensors on the foregoing:

A. Pressure of the piezo element, flash mounted as used in E.P. Controls since 1997 (see FIG. 11 of the transducer, signal cable and electronics). The piezo element and charge amplifier (integrated in the electronics) are fitted so as to be isolated from each other with regard to temperatures.

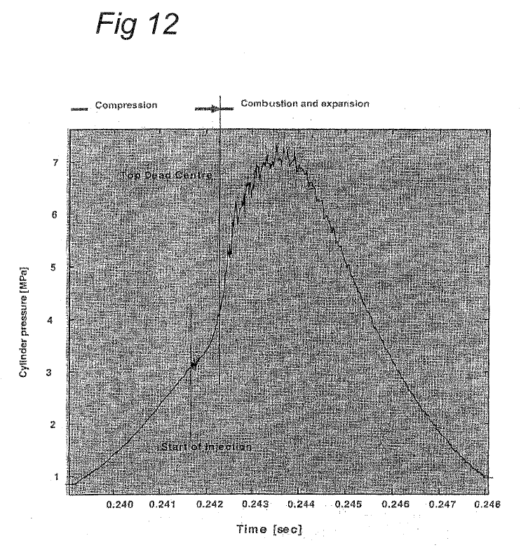

Piezo sensors are ideal for recording transients. The sensors designed by us have a design service life of 10⁹ cycles. In the first applications, use was made of a water-cooled container in which the sensor membrane was mounted flush in the combustion chamber. The cooling was necessary on account of the fact that the charge amplifier was fitted just above the transducer crystal. In the new version, the crystal is separated from the combustion chamber by means of a membrane and the charge amplification is removed further from the crystal to a milder temperature environment having an acceptable temperature drift. Appended is a pressure graph (FIG. 12). N.B. An error in the crank angle position of 1° introduces, as a rule of thumb, a cylinder pressure measurement error of 10% pₘᵢ. The controller is sold for, inter alia, ocean shipping where the pressure transducers are used particularly beneficially as a component of our smart diesel injection controls.

B. Thermocouple temperature standard.

C. Composition (depending on type), for example NOₓ (see photo). Standard sensor series available from VDO, the recording element being placed in the hot gas stream and the electronics being removed therefrom. As a derivative function of the measurement, the O₂ and peroxide concentrations can be measured using the same basic elements.

The sensor is constructed around the ceramic carrier for the diffuser. The diffuser is placed in the gas stream between the combustion chamber and ceramic bearings. These bearings require lubrication, in this case a controlled gas stream which (according to tribology) uses a pocket volume (for example a type of blind gut buffer).

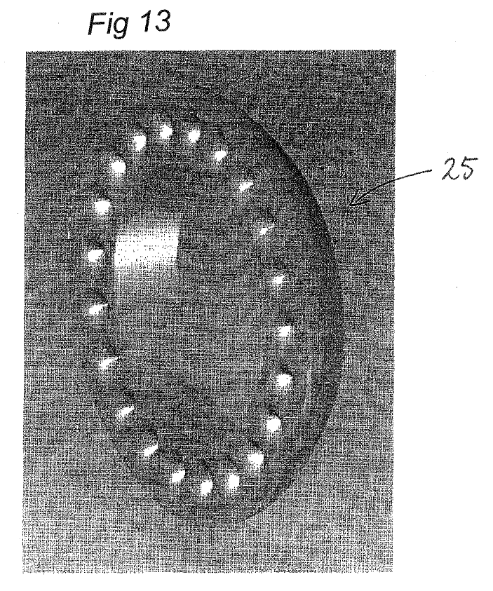

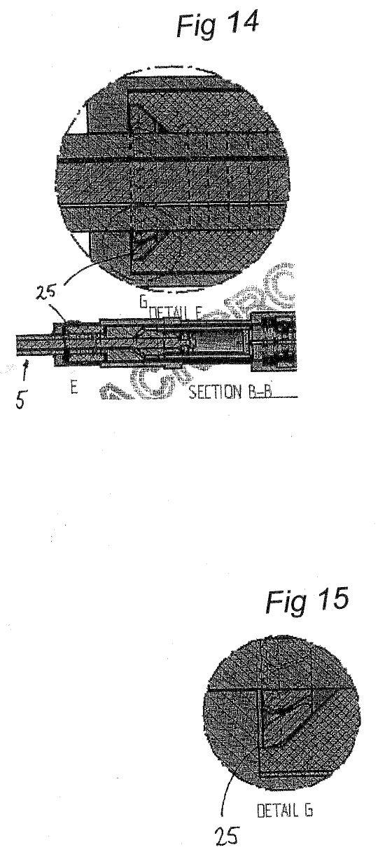

The gas pressure passes successively through a) the passage between the material thickness of the cylinder head, b) the material thickness of the atomizer housing, c) the diffuser and NOₓ (or other composition) measurement, ceramic bearings and d) the pocket volume. The constantly changing gas pressure provides a reciprocal gas stream which is both sufficiently large for lubrication of the bearings and alternating charge for the sensor and sufficiently small not to cause any load with regard to the compression ratio. N.B.: this sensor is therefore not in direct contact with the flame front. See FIGS. 13-15: The sensor diffuser 25, detail G and integration of the composition sensor (NOₓ).

D. Density. Can be obtained as a derivative function with the piezo element. Can be measured quickly using chemiluminescence technology (expensive). This has already been carried out successfully under laboratory conditions in Nijmegen and Eindhoven.

E. Ionization. Peroxide measurement or electron spin resonance (ESR) spectroscopy (expensive), or “simply” measure the ionic current as is done, for example, in central heating boilers (inexpensive and reliable).

F. Position. Integrated in electronics.

G. (Rotational) speed. Integrated in electronics.

H. Conductivity. μS measurement.

I. Field strength. Field strength measurement between 2 metal objects.

J. Gradients

K. etc.

48. Overview of possible actuators which can be activated in the manner described under 46, for:

A. Heating

B. Valve operation for the injection channels

C. Electrostatic influence of the flows of fuel

D. Electrostatic influence of the gas streams

E. Ignition mechanisms, for example a pulsed laser diode. The diode is positioned centrally below the injection nozzles and the activation in the electronics processed via, for example, what is known as a collimator through the central axis. These pulsed laser diodes are available in various embodiments; however, for the energy density required in the present case, a license is required. The temperature sensitivity of laser diodes does not differ significantly from “normal electronics”, i.e. in this case too the electronic components determine the application. We opted to use a collimator in which the actual diode is placed in the integrated electronics and the beam is conducted via the collimator to the combustion space where it is separated by a “thick” quartz crystal window suitable for this purpose. See, for example, the measuring set-up at the Catholic University of Nijmegen (KUN) which used laser-induced fluorescence technology and monitored a comparable method. The window is sealed “cold” on a polished metal and/or ceramic surface, the window being fitted with prestress. Contamination is a problem with malfunctioning injectors. It is expected that the method proposed by us will have such a marked effect that the contamination which occurs as a result of the electrostatically influenced gas stream will be purified sufficiently to prevent any adverse effects on operability. The free radicals released in the combustion chamber are, for example, known to have a “cleansing” effect on the window. To date, we do not have sufficient empirical experience in this application. However, it is obvious that any problems of this type which arise will be solved.

F. Operation for catalytic converters

G. Positional control

H. etc.

### Background to FIGS. 8-10

### A. Recovery:

For standard prime movers, roughly 60% of the energy latently present in the fuel is lost (is “wasted”) as a result of inefficiency and heat losses in exhaust gases, cooling, etc. In the case of continual operation, roughly 35% to 60% of this can be recovered after deduction of the necessary conversion energy. This recovered energy can be converted by means of heat pumps into production steam which in turn:

a) can be supplied directly to HICI as a moderator (energy transition);

b) be supplied to a steam generator for producing electricity (energy transition), which is also necessary for the splitting process;

c) be provided to the processes for recuperation and decomposition (energy conversion);

d) be supplied with the O₂ obtained from the splitting of H₂O and CO₂ as a “dissolved oxidizer” in the (preferably dry) conveyance of steam and/or be introduced directly into the combustion chamber or otherwise used. This current of (dry) steam is therefore to be regarded both as a moderator and as a fuel (energy conversion and transition).

### B. Splitting:

a) A plurality of processes, of which electrolysis is the best known, are possible for the splitting of, to put it simply, 2H₂O into 2H₂+O₂.

b) The splitting of CO₂into C and O₂ is, on the other hand, somewhat less straightforward and there is at present no universally accepted process for this purpose. (Artificial) photosynthesis and catalytic processes are currently being researched at various sites. These processes are not expected to be available on an economic scale in the near future. Once this is the case, it will be possible to use this splitting for addition to the process as, for example, set out under A.d).

c) The 2H₂ and C obtained from the splitting process(es) can be converted relatively simply to form new fuels (for example, transition of CO₂ and H₂ to methanol) but they can also be supplied to the combustion process “directly” via intermediate storage, thus forming in fact a small circuit.

d) The energy required for splitting and conversion can also be obtained from other sources. Examples include solar energy. The conversion products should be stored in (small) intermediate storage facilities.

e) The transition substances obtained from the splitting and conversion may have originated directly from the source of the “individual prime mover” or from any other source. CO₂ and H₂O originating from external sources should thus be regarded as fuel and CO₂ (viewed globally)-reducing moderators.

### C. Control:

a) Control of the process can be assumed by the HICI controller because this already makes provision for the take-off edge (sensors and actuators in conjunction with the power requirement needed for loading). An additional control module for recovery (A) and splitting (B) is therefore the logical consequence.

b) The manner in which the preparation, splitting, recuperation, conversions, transitions, conditioning and storage are regulated does not come under the scope of the present patent application, although the assembly as a whole or in separate parts thereof, in combination with the described injection process of the introduction under rotation of fuels, moderators, inhibitors and additives, does.

d) The process is therefore to be regarded as a partly circular, stochastic process allowing considerable energy saving, CO₂ reduction and emission reductions to be achieved at source.

Acceleration of the prime mover is (almost) always an indication of an excess of fuel. Invariably, this also leads to an excess of emissions and, in particular, PM/soot if standard injectors are used. If the HICI system is used, firstly less fuel is required for this acceleration and secondly this results in a considerable reduction of PM compared to the use of standard injectors.

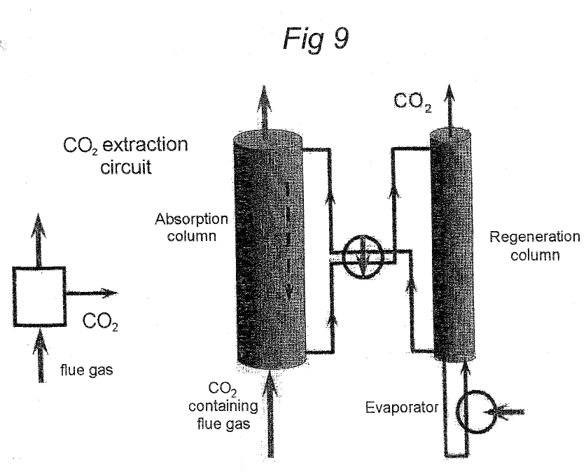

The extraction of CO₂ from the gas stream is indicated in the CO₂ extraction circuit (see FIGS. 8 and 9).

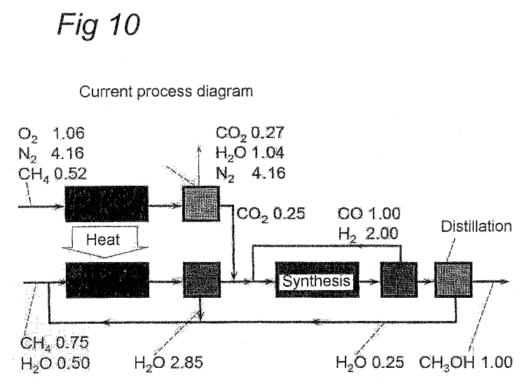

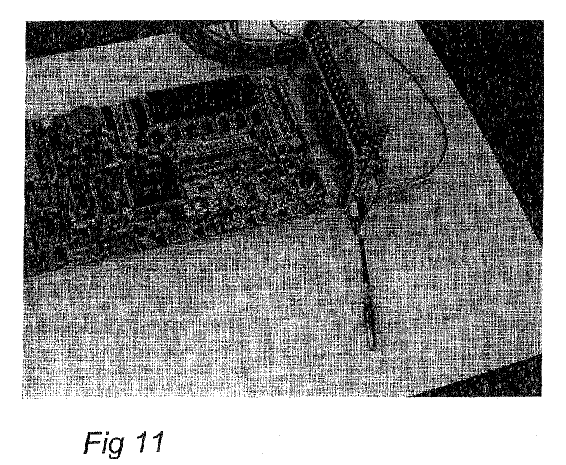

Also appended is a process diagram (see FIG. 10) such as that used by the Gasunie gas infrastructure company for the production of methanol. In this case, natural gas (methane) and CO₂ are processed to form methanol. For the installations in which we intend to use pyrolysis processes for either RDF or biomass processing, CO is derived from this process and replaces in the above-mentioned diagram the CO from the natural gas.

For stationary set-ups, we intend to use the CO₂ as manure for algae in a basin, which will then be harvested and either fermented (ethanol) as aquatic green or be pyrolyzed to form oil.

It will be understood that the foregoing description is intended to illustrate the carrying-out of preferred embodiments of the invention and not to limit the scope of the invention. Starting from the foregoing discussion, a person skilled in the art will immediately think of a large number of variations which fall under the spirit and the scope of the present invention.

1. Injection device for the injecting of fuel into a combustion chamber, wherein the injection device comprises:
a housing (1) which is rigidly connected to the combustion chamber,
an injection part (2) which is rotatably connected to the housing (1) and which is drivable by means of an actuator in order to rotate with respect to the housing (1) about a central axis (3),
a supply conduit (4) which is fluidically connected to the combustion chamber for the pressurized introduction of a fuel into the combustion chamber and which comprises a fluid-tight coupling (12) between the housing (1) and the injection part (2);
an injection nozzle (5) which is rigidly connected to the injection part (2) and which comprises an atomizer (6) having an atomizer opening which is fluidically connected to the supply conduit (4) for the introduction of fuel into the combustion chamber, while the injection nozzle (5) rotates, the injection device further comprising at least one further supply conduit (4) for the pressurized introduction of a fluid into the combustion chamber.

2. Injection device according to claim 1, wherein the fluid comprises a further fuel.

3. Injection device according to claim 1, wherein the fluid comprises a moderator to moderate the combustion process.

4. Injection device according to claim 1, wherein the actuator comprises a converter for the pressurized conversion of the fluid or the fuel into a driving force to rotate the injection part (2) with respect to the housing (1).

5. Injection device according to claim 1, wherein the fluid-tight coupling (12) comprises a circumferential channel which is provided on the rotatable injection part (2) to provide a fluid connection between the housing (1) and the injection part (2), irrespective of their mutual rotational position.

6. Injection device according to claim 1, wherein the injection nozzle (5) comprises:
blades (8) for swirling fluid in the combustion chamber,
a central cavity (7) around which the blades (8) are arranged,
and recesses (9) in the blades (8),
to circulate fluid in the combustion chamber along the injection nozzle (5).

7. Injection device according to claim 6, wherein blades (8) are provided with an atomizer (6) and the atomizers (6) are located in a plane substantially perpendicular to the central axis (3) and wherein atomizer openings are oriented to inject the fuel or the fluid into the combustion chamber at an angle to the plane.

8. Injection device according to claim 1, wherein supply conduits (4) each open into a separate atomizer (6), arranged to mix the fuel and the fluid in the combustion chamber only.

9. Injection device according to claim 1, wherein the injection part (2) comprises an electrode arranged to electrostatically influence the fuel and/or the fluid and to provide better distribution in the combustion chamber.

10. Injection device according to claim 9, wherein the electrode is provided at the supply conduit (4) to the atomizer (6) for electrostatically influencing the fuel and/or the fluid.

11. Injection device according to claim 9, wherein the electrode (11) is provided in the central cavity (7) in the injection nozzle (5) for electrostatically influencing fuel present in the combustion chamber and/or the fluid.

12. Injection device according to claim 1, wherein the injection nozzle (5) comprises an electrically conductive layer for heating the fuel and/or the fluid.

13. Injection device according to claim 1, wherein an ignition means is further provided arranged to supply energy and to influence the combustion process.

14. Injection device according to claim 1, wherein the injection part (2) comprises catalytic layers arranged to speed up the combustion process.

15. Injection device according to claim 1, wherein the injection part (2) is provided with at least one sensor and wherein the injection part (2) and the housing (1) are provided with electromagnetic signal transmission means arranged to contactlessly transmit data between the housing (1) and the injection part (2).

16. Injection device according to claim 15, wherein the sensor comprises a temperature sensor arranged to measure the temperature in the combustion chamber.

17. Injection device according to claim 15, wherein the sensor comprises a pressure sensor arranged to measure the pressure in the combustion chamber.

18. Injection device according to claim 17, wherein the pressure sensor comprises a piezo element.

19. Injection device according to claim 15, wherein the injection device comprises a generator, terminals of the generator being provided on the injection part (2) arranged to produce electrical energy on the injection part (2).

20. Injection device according to claim 1, wherein the injection nozzle (5) comprises at least one exit surface from which fluid issues at an exit speed perpendicularly to the exit surface and wherein the injection nozzle (5) has a speed component in the exit surface that is greater than the exit speed.

21. Internal combustion engine provided with an injection device according to claim 1.

22. Internal combustion engine according to claim 21, wherein the internal combustion engine is an engine selected from the following group: a diesel engine, a petrol engine, a gas engine and a turbine.

23. Internal Combustion engine according to either claim 21, wherein the rotation of the injection part (2) is in the direction of the swirl in the combustion chamber.

24. Method for the injecting of fuel and/or fluid into a combustion chamber of an internal combustion engine according to claim 21, including one or more of the following steps:
rotating the injection part (2),
injecting in succession various fuels into the combustion space over one combustion cycle,
measuring the temperature in the combustion space,
measuring the pressure in the combustion space,
measuring the NOₓ content,
injecting a moderator for moderating the combustion process and/or influencing the temperature,
supplying ignition energy into the combustion space,
electrostatically influencing the fluid in the combustion space.

25. Method according to claim 24, wherein the injection part (2) rotates before the fuel is injected for obtaining an optimum temperature distribution for injecting of the fuel.

26. Method according to claim 24, wherein gases which have reacted within a combustion chamber of the internal combustion engine are mixed with non-reacted gases for taking part in the next combustion process within the combustion chamber.

27. Method according to claim 24, wherein the fuel is injected at an angle to the central axis (3) such that the fuel does not touch any parts of the combustion chamber for reducing thermal loading and erosion of the parts of the combustion chamber.

28. Method according to claim 24, wherein the fuel is injected at pressure and the injection part (2) rotates at speed for preventing agglomeration of fuel particles.

29. Method according to claim 24, wherein the injection part (2) rotates during the inlet stroke for reducing the ignition delay.

30. Method according to claim 24, wherein the injection part (2) rotates during the working stroke for combating the formation of soot.

31. Method according to claim 24, wherein the injection part (2) rotates during the outlet stroke for promoting afterburning.

32. Method according to claim 24, wherein the injection part (2) is not driven over a portion of the combustion cycle.

33. Method according to claim 24, wherein after initiation of the combustion the temperature in the combustion chamber is measured and adjusted, by injecting of a moderator, to below a temperature level at which thermal NOₓ is produced.

34. Method according to claim 24, wherein the leakage rate is regulated per combustion cycle and per combustion chamber for eliminating differences in capacity between combustion chambers.

35. Method according to claim 24, wherein a needle closes the atomizer opening as a result of centripetal normal force during rotation of the injection part (2).

36.-37. (canceled)
